(19) United States
(12) Patent Application Publication
(10) Pub. No.: US 2018/0365624 A1
(43) Pub. Date: Dec. 20, 2018

(54) ANONYMIZED ALLOCATIONS-BASED WORKFORCE MANAGEMENT SYSTEM

(71) Applicant: Walmart Apollo, LLC, Bentonville, AR (US)

(72) Inventors: Sunil Pati, Bentonville, AR (US); Inderjeet Chauhan, Bentonville, AR (US); Subodh Kumar Pandey, Bentonville, AR (US); Ajay Kumar Gautam, Bentonville, AR (US); Trinadh Kumar Nadella, Bentonville, AR (US); Pranay Kumar Chavva, Rogers, AR (US); Matthew McCleskey, Rogers, AR (US)

(21) Appl. No.: 15/974,662

(22) Filed: May 8, 2018

Related U.S. Application Data
(60) Provisional application No. 62/522,492, filed on Jun. 20, 2017.

(51) Int. Cl. G06Q 10/06; G06Q 10/04

(52) U.S. Cl. CPC G06Q 10/063116; G06Q 10/04

(57) ABSTRACT

Examples provide a context-specific unbiased workforce allocation system. A workforce management component analyzes workforce data, associated workforce assets and an individual environment to generate a workforce assets allocation. Individual unique randomized identifiers (UR-IDs) are generated for each workforce asset in the plurality of workforce assets associated with the individual environment on a per allocation basis. A first UR-ID is associated with an individual workforce asset for a first allocation and a second UR-ID is associated with the individual workforce asset for the second allocation to maintain anonymity of workforce assets across allocations. The generated UR-IDs and corresponding allocation data are stored in an anonymized workforce data repository. A parity score is generated for each allocation of workforce assets. The parity score identifies anomalies in the allocations and provides feedback used to update the workforce asset allocations to minimize or eliminate the anomalies.

### BACKGROUND

Workforce management refers to assigning workers in a workforce to various staff positions, work shifts, and/or work hours. A workforce refers to a pool of available workers. Assigning an appropriate number of workers to each shift is important for cost management. For example, overstaffing a shift results in unnecessary expense for the additional staff. In addition, understaffing a shift may result in decreased job performance quality due to over-extension of workers, customer dissatisfaction, and higher worker turnover.

In determining worker assignments, human managers typically perform a manual review of staff openings and worker availability information to make worker shift assignments. This manual review and assignment process is time consuming, inefficient, and burdensome for managers and other workers. This process may also result in unequitable work assignments due to human error, bias, and/or insufficient workforce information.

### SUMMARY

Examples of the disclosure provide a system for unbiased workforce allocation. The system includes an interface coupled to a communication network; at least one processor coupled to the interface via the communication network; and an anonymization module implemented on the at least one processor. The anonymization module obtains workforce data from a data storage device. The workforce data includes information corresponding to a plurality of workforce assets and a plurality of allocations. The anonymization module generates individual unique randomized identifiers for individual workforce assets in the plurality of workforce assets on a per allocation basis. An individual workforce asset is associated with a first unique randomized identifier for a first allocation and a second unique randomized identifier for a second allocation. The anonymization module stores the generated individual unique randomized identifiers and corresponding allocation data at an anonymized workforce data repository. A workforce allocation module, implemented on the at least one processor, generates a new allocation using the anonymized workforce data repository to assign one or more workforce assets to one or more portions of the new allocation. A parity control module, implemented on the at least one processor, analyzes the generated new allocation in real-time to generate a parity score corresponding to allocation of the one or more workforce assets relative to the generated new allocation, and outputs the generated parity score.

Other examples provide a method for context-specific unbiased workforce forecasting implemented on at least one processor. Workforce data associated with an individual environment is obtained via a communication network coupled to the at least one processor. The workforce data includes information corresponding to a plurality of workforce assets. Individual unique randomized identifiers are computed for individual workforce assets in the plurality of workforce assets associated with the individual environment on a per allocation basis. A first unique randomized identifier is associated with an individual workforce asset for a first allocation and a second unique randomized identifier is associated with the individual workforce asset for the second allocation. The generated individual unique randomized identifiers and corresponding allocation data are stored at an anonymized workforce data repository. A new allocation for the individual environment is generated using the anonymized workforce data repository. A new unique randomized identifier is computed for the individual workforce asset. The computed new unique randomized identifier is associated with a corresponding portion of the new allocation.

Still other examples provide one or more computer storage devices having computer-executable instructions stored thereon for context-specific unbiased workface allocation. An anonymization component is executed by the computer to obtain workforce data, generate unique randomized identifiers for the individual workforce assets on a per allocation basis, and store the generated unique randomized identifiers and corresponding allocation data at an anonymized workforce data repository. The workforce data includes information corresponding to a plurality of workforce assets and a plurality of allocations. A workforce allocation component is executed by the computer to generate a new allocation using the anonymized workforce data repository to assign one or more workforce assets to one or more portions of the new allocation. A parity control component is executed by the computer to analyze the generated new allocation in real-time to output a parity score corresponding to allocation of the one or more workforce assets relative to the generated new allocation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing device for generating anonymized workforce allocations.

FIG. 2 is an exemplary block diagram illustrating a workforce management system for performing anonymized allocations-based work force management.

FIG. 3 is an exemplary block diagram illustrating a workforce management component.

FIG. 4 is an exemplary block diagram illustrating a workforce allocation.

FIG. 5 is an exemplary block diagram illustrating an anonymized workforce data repository.

FIG. 6 is an exemplary block diagram illustrating a plurality of unique randomized identifiers generated by an anonymization module.

FIG. 7 is an exemplary block diagram illustrating a plurality of parity scores output via a user interface.

FIG. 8 is an exemplary flow chart illustrating operation of the computing device to generate an anonymized workforce allocation.

FIG. 9 is an exemplary flow chart illustrating operation of the computing device to generate a parity score associated with a workforce allocation.

FIG. 10 is an exemplary flow chart illustrating operation of the computing device to generate a predicted future workforce allocation.

FIG. 11 is an exemplary flow chart illustrating operation of the computing device to analyze a plurality of parity scores.

Corresponding reference characters indicate corresponding parts throughout the drawings.

### DETAILED DESCRIPTION

Referring to the figures, examples of the disclosure enable workforce management using anonymized workforce data to generate automated workforce asset allocations. As used herein, an allocation refers to an assignment of one or more workforce assets to work days, work shifts, work hours, work tasks, work area, department, job title, salary, vacation time, vacation approval, or other workforce-related assignments. A workforce asset refers to a human worker, associate, manager, volunteer, contractor, or other type of worker. A workforce asset may include a full-time worker, part-time worker, paid worker, seasonal worker, and/or unpaid volunteer.

In some examples, an anonymization module generates individual unique randomized identifiers for individual workforce assets on a per allocation basis. An individual workforce asset is associated with a first unique randomized identifier (UR-ID) for a first allocation and a second UR-ID for a second allocation. When personnel are assigned to a task, work shift, or other workforce allocation, only the UR-ID is known to the workforce manager or other supervising agent. This enables unbiased anonymization of workforce data, work shift assignments, and other allocations with greater equity and improved security of workforce asset information.

Other examples provide a workforce allocation module that generates a new allocation of workforce personnel to job tasks, number of hours to be worked, work shift, or other workforce allocations using the anonymized workforce data to assign one or more workforce assets to one or more portions of the new allocation. This enables automated, unbiased and anonymized workforce allocations. The workforce allocation module further improves speed and efficiency of making workforce allocations while reducing error rate.

Still other examples provide a parity control module that automatically analyzes one or more allocations in real-time to generate and/or output one or more parity scores. A parity score is an indicator of a level of optimization and/or bias in workforce assignments. A parity score may be a score for an individual workforce asset, a single work location, as well as multiple work locations. For example, a parity score may be a score for an individual worker, a single store, or a plurality of stores relative to one or more workforce asset allocations. The parity scores provide feedback to update workforce allocations and for generating new workforce allocations in the future. This enables allocations to be generated and updated with improved speed and efficiency while ensuring unbiased workforce allocations. The parity scores further enable the workforce management system to autonomously generate workforce assignments while avoiding over-staffing, under-staffing, or other undesirable staffing assignments.

In still other examples, work hours for different shifts receive different payment. For example, a worker working the night shift or a holiday shift may receive higher pay per hour than a worker working a day shift or non-holiday shift. The parity scores in these examples indicate equity of pay among workers assigned to the same or similar staffing positions. This improves fair distribution of high value work assignments and equitable pay for disparate workers.

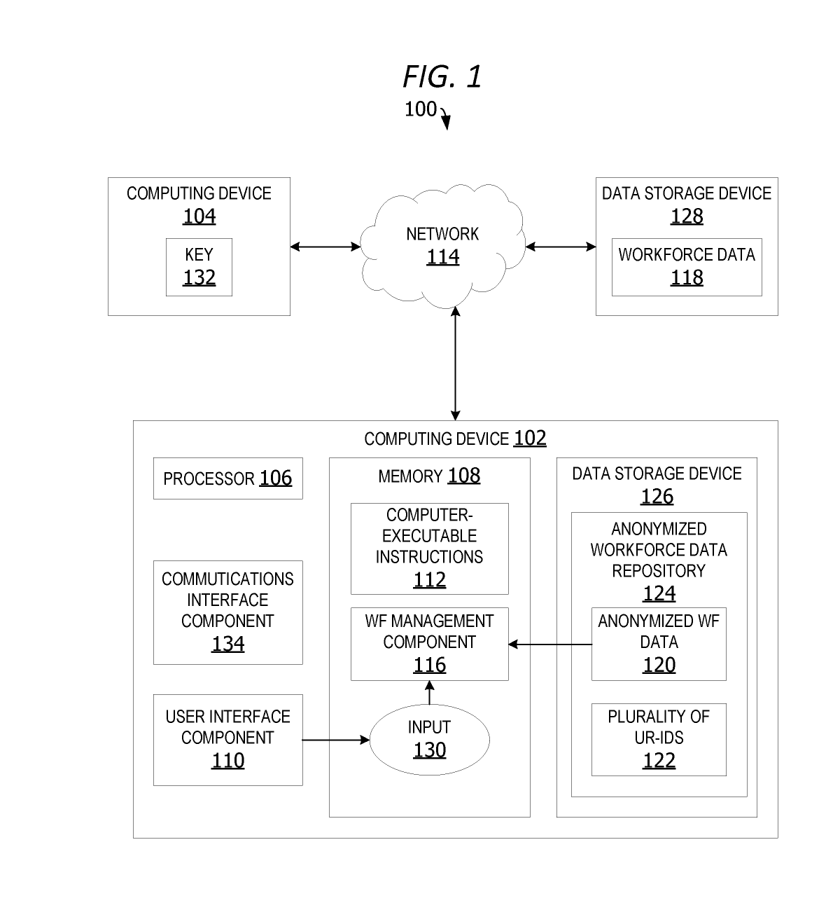

Referring again to FIG. 1, an exemplary block diagram illustrates a workforce management system 100 for generating anonymized workforce allocations. A computing device 102 represents any device executing instructions (e.g., as application programs, operating system functionality, or both) to implement the operations and functionality associated with the computing device 102.

A computing device, such as computing device 102 or 104, may include a mobile computing device or any other portable device. In some examples, the mobile computing device includes a mobile telephone, laptop, tablet, computing pad, netbook, gaming device, and/or portable media player. The computing device may also include less portable devices such as desktop personal computers, kiosks, tabletop devices, industrial control devices, wireless charging stations, and electric automobile charging stations. Additionally, the computing device may represent a group of processing units or other computing devices.

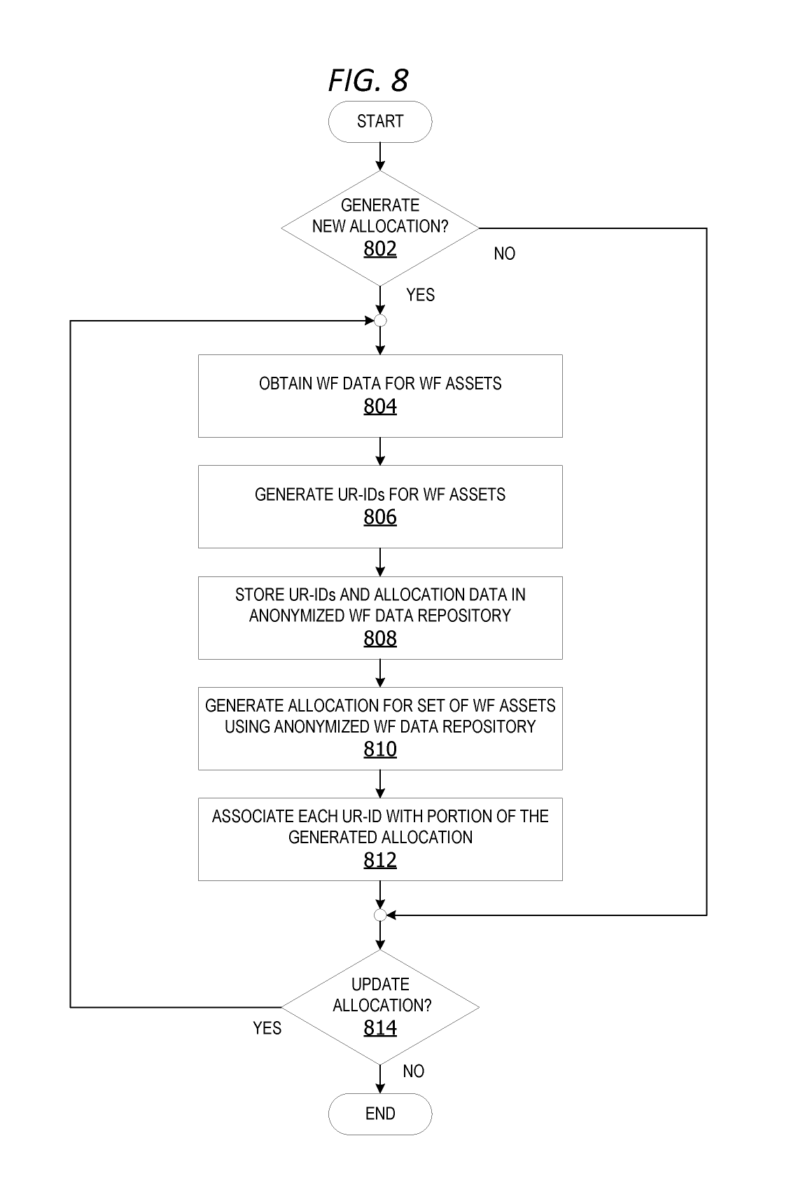

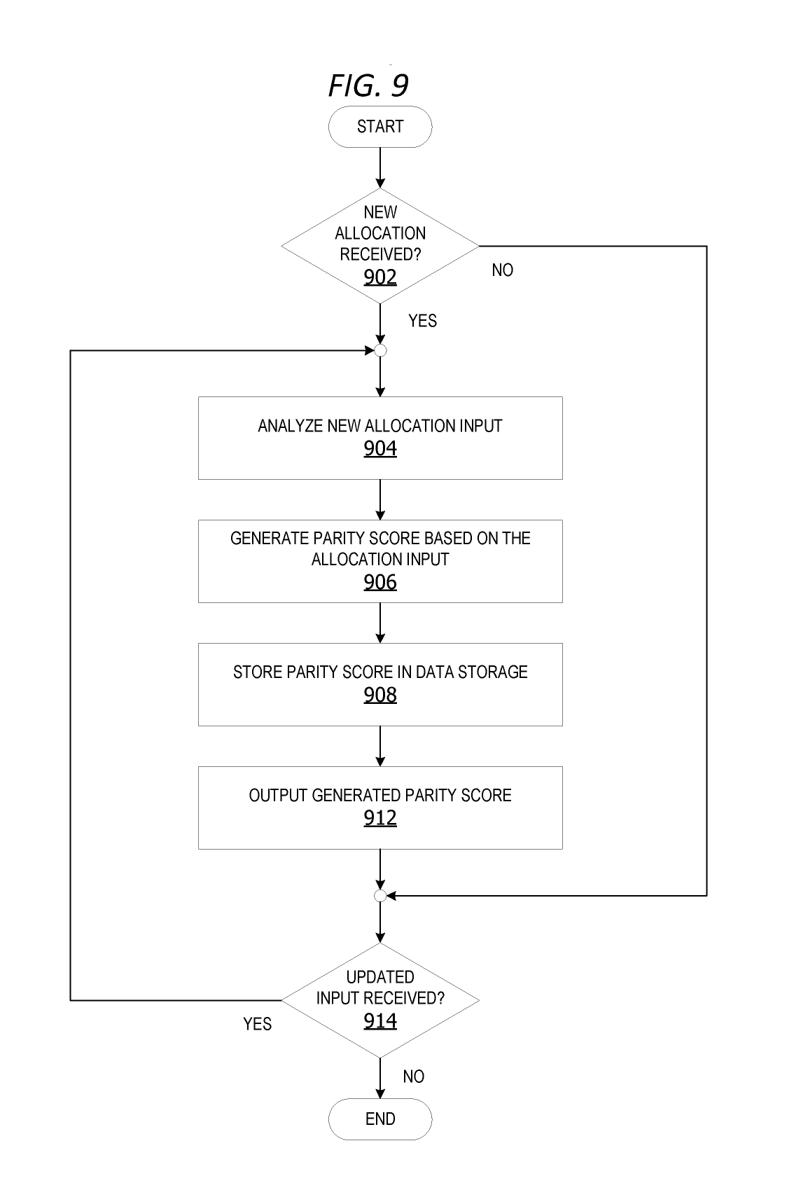

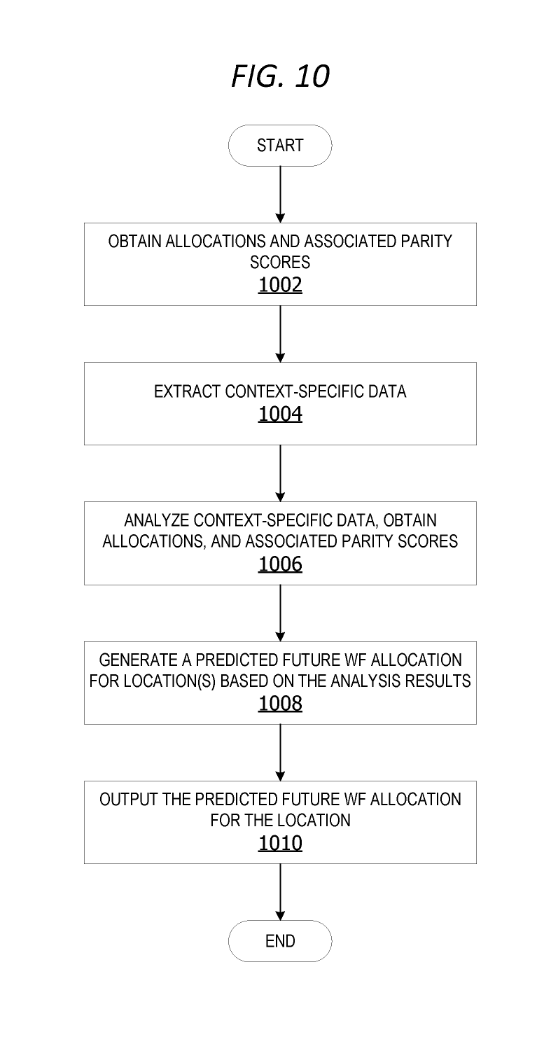

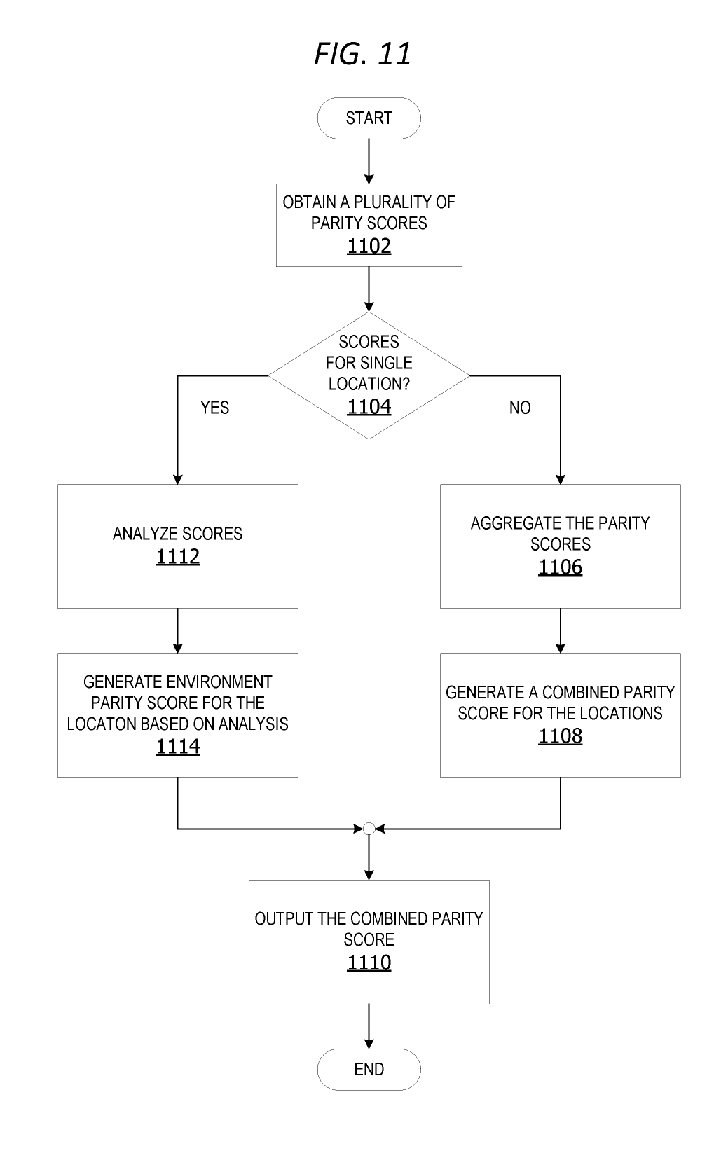

In some examples, the computing device 102 has at least one processor 106, a memory 108, and at least one user interface component 110. The processor 106 includes any quantity of processing units, and is programmed to execute computer-executable instructions 112 for implementing aspects of the examples. The instructions may be performed by the processor 106 or by multiple processors within the computing device 102, or performed by a processor external to the computing device. In some examples, the processor 106 is programmed to execute instructions such as those illustrated in the figures (e.g., FIG. 8, FIG. 9, FIG. 10, and FIG. 11).

In some examples, the processor 106 represents an implementation of analog techniques to perform the operations described herein. For example, the operations may be performed by an analog computing device and/or a digital computing device.

The computing device 102 further has one or more computer-readable media such as the memory 108. The memory 108 includes any quantity of media associated with or accessible by the computing device 102. The memory 108 may be internal to the computing device 102 (as shown in FIG. 1), external to the computing device (not shown), or both (not shown). In some examples, the memory 108 includes read-only memory and/or memory wired into an analog computing device.

The memory 108 stores data, such as one or more applications. The applications, when executed by the processor 106, operate to perform functionality on the computing device 102. The applications may communicate with counterpart applications or services, such as web services accessible via a network 114. For example, the applications may represent downloaded client-side applications that correspond to server-side services executing in a cloud.

The network 114, in some examples, is implemented by one or more physical network components, such as, but without limitation, routers, switches, network interface cards (NICs), and other network devices. The network 114 may be any type of network for enabling communications with remote computing devices, such as, but not limited to, a local area network (LAN), a subnet, a wide area network (WAN), a wireless (Wi-Fi) network, or any other type of network. In this example, the network 114 is a WAN accessible to the public, such as the Internet.

The memory 108 further stores one or more computer-executable components. Exemplary components include a workforce (WF) management component 116. The WF management component 116, when executed by the processor 106 of the computing device 102, causes the processor 106 to obtain workforce data 118 associated with an individual environment via a communication network 114 coupled to the at least one processor 106.

Workforce data is data associated with the workforce demands of one or more selected locations and the workforce supply available at the selected one or more locations. The workforce data 118 includes information corresponding to one or more workforce assets. For example, the workforce data 118 may include, without limitation, a number of available workforce assets, job titles of available workforce assets, job skills of available workforce assets, number of work hours the workforce asset is available to work, the workforce assets' preferred number of work hours, the weekly hours worked by the workforce asset, weekly hours of work available to be assigned to a workforce asset, number of high value hours already received by the workforce asset, etc. The workforce data 118 in other examples may include a store number, store type, fiscal year, payroll run date, full-time versus part-time status, and/or quantity of hours per pay period. The store type may be, for example, but without limitation, grocery store, sports center, automotive center, hardware store, etc.

High value hours are work hours preferred by workers. High value hours in some examples include holiday work hours which are associated with higher pay than regular work hours. In other examples, night shift hours may be in higher demand by workers than day shift hours. The night shift hours are considered high value hours because the pay is higher for night shift assignments and/or because more workers request night shift hours than are available for assignment. In some examples, the workforce data 118 indicates which available work hours to be assigned to workforce assets are in greatest demand or associated with higher pay than other available work hours.

The WF management component 116, in some examples, is further executed to cause the processor 106 to compute individual unique randomized identifiers (UR-IDs) for individual workforce assets in a plurality of workforce assets associated with the individual environment on a per allocation basis. A first UR-ID is associated with an individual workforce asset for a first allocation. A second UR-ID is associated with the same individual workforce asset for the second allocation.

In other examples, the WF management component 116 is further executed to cause the processor 106 to store the plurality of UR-IDs 122, corresponding allocation data, and/or anonymized workforce data 120 at an anonymized workforce data repository 124. The workforce data in the anonymized workforce data repository 124 excludes identifying information associated with workforce assets. A user viewing anonymized workforce data 120 or any other data associated with the anonymized workforce data repository 124 is unable to identify a particular worker or determine an identity of a worker assigned to a particular shift, work hours allocated, or rate of pay.

In other examples, a computing device 104 remote to the anonymized workforce data repository 124 includes a key 132 for decrypting UR-IDs. The key 132 enables the computing device 104 to decode the anonymized workforce data 120. The key 132 matches one or more UR-IDs associated with workforce data to information identifying one or more workforce assets.

In some examples, the key 132 is a cross-reference table including workforce asset identification numbers identifying workers and an associated cross-reference. The cross-reference may be utilized by the server to locate a UR-ID for the workforce asset.

The anonymized workforce data repository 124 is stored within a data storage device 126 in other examples. The data storage device 126 may be implemented in some examples as one or more spinning magnetic disks or solid state drives, such as, for example, one or more hard disks, and/or one or more flash drives. A data storage device 126 in other examples may include a redundant array of independent disks (RAID) array.

In still other examples, the anonymized workforce data repository 124 is stored on a remote data storage device, such as data storage device 128. The remote data storage device 128 is accessible by the workforce management component via the network 114.

The WF management component 116, in some examples, is further executed to cause the processor 106 to generate a new allocation for the individual environment using the anonymized workforce data repository 124. In other examples, the WF management component 116 computes a new UR-ID for the individual workforce asset and associates the computed new UR-ID with a corresponding portion of the new allocation.

In other examples, the WF management component 116 receives allocation input 130 via the communication network 114. The allocation input 130 includes allocation data describing one or more generated allocations. The input 130 may include allocations utilized in the past, allocations generated for future utilization, and/or allocations currently being used by one or more stores at one or more locations. The input 130 is received via the user interface component 110 in this example. The user may manually enter the allocation input 130. In other examples, the WF management component 116 utilizes the user interface component 110 to autonomously retrieve the allocation input 130 from a data storage device, database, repository, or other data store without human user interventions or assistance. In other examples, the input 130 may be received from a remote computing device 104 via the network 114.

In other examples, the WF management component 116 includes an analysis engine and/or a machine learning component. The input 130 in these non-limiting examples is used in part to train the analysis engine and/or the machine learning component of the WF management component 116 to more efficiently and accurately generate anonymized workforce allocations using UR-IDs and other allocations input. In some examples, feedback received from one or more users is utilized to train the WF management component 116 to improve equal distribution of hours/pay to employees and improve accuracy of generated parity scores such that scores more accurately reflect each store's success or failure with regard to achieving workforce allocation parity.

The WF management component 116 assigns the one or more workforce assets to one or more portions of the plurality of portions. In yet other examples, the WF management component 116 analyzes the assigned workforce assets as the allocation inputs are received to generate a dynamic parity score. The dynamic parity score changes as an individual allocation input is processed to reflect an impact of the individual allocation input on the dynamic parity score.

In this example, the workforce data 118 is located on a data storage that is remote from the computing device 102. In other examples, the workforce data 118 is located on a data store internal to the computing device 102 or otherwise local to the computing device 102.

In some examples, the communications interface component 134 includes a network interface card and/or computer-executable instructions (e.g., a driver) for operating the network interface card. Communication between the computing device and other devices may occur using any protocol or mechanism over any wired or wireless connection. In some examples, the communications interface component 134 is operable with short range communication technologies such as by using near-field communication (NFC) tags.

In some examples, the user interface component 110 includes a graphics card for displaying data to the user and receiving data from the user. The user interface component 110 may also include computer-executable instructions (e.g., a driver) for operating the graphics card. Further, the user interface component 110 may include a display (e.g., a touch screen display or natural user interface) and/or computer-executable instructions (e.g., a driver) for operating the display. The user interface component may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device in a particular way.

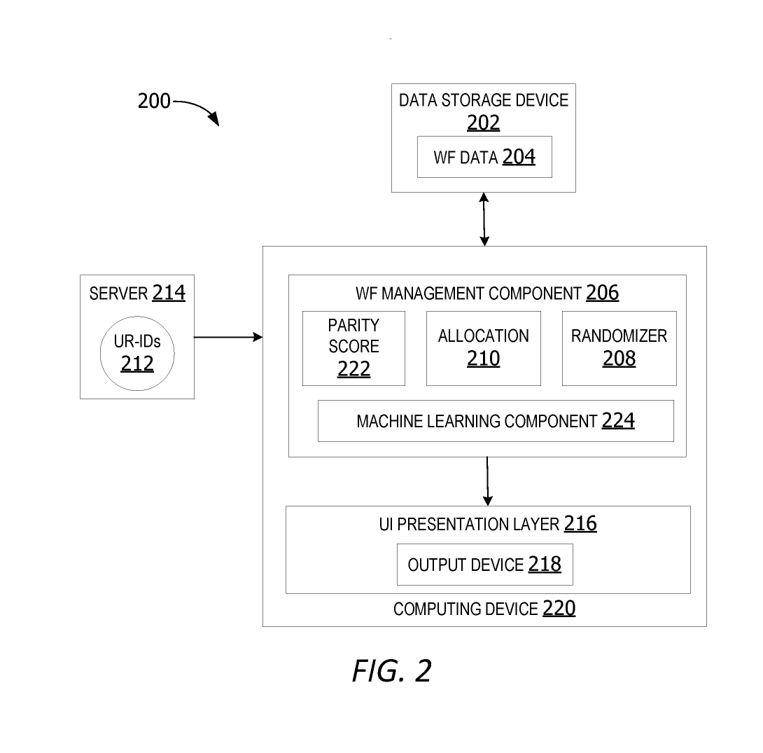

FIG. 2 is an exemplary block diagram illustrating a workforce management system for performing anonymized allocations-based work force management. The workforce management system 200 in this non-limiting example includes a data storage device 202 storing WF data 204, such as, but not limited to, workforce data 118 in FIG. 1. In some examples, the data storage device 202 may include an extract, transform, load (ETL) database process for data management.

The computing device 220 may be any type of computing device, such as, but not limited to, the computing device 102 and/or 104 in FIG. 1. In some non-limiting examples, the computing device 220 may be implemented as a structured query language (SQL) server.

The WF data 204, in this non-limiting example, includes a store shift plan. The store shift plan includes information about workforce asset assignments to be made for each shift during a given time frame (a time horizon) at the store. For example, a time horizon may be a thirteen-week period. Each shift to be assigned during that time horizon includes a number of workforce assets needed, workforce asset roles (job roles/titles), number of hours in each shift, number of hours to be assigned each day or week, identification of high value hours to be assigned, etc. The WF data 204 may also include workforce asset information such as, but not limited to, the workforce asset's job title/skills, preferred work hours, available work hours, hours already worked during a given time period, etc.

The workforce management component 206 includes a randomizer 208. The randomizer 208 in some examples generates each allocation assigning a workforce asset to a work assignment in a round-robin fashion based on input data, factors, and feedback in the form of parity scores. A work assignment is an assignment of a workforce asset to a particular job task, duty, shift, number of hours, etc. The randomizer takes workforce supply and store demand (number of workers needed for each department/task to be assigned to each work shift) into account to generate a workforce allocation 210. The randomizer 208 utilizes an unbiased, round-robin approach to allocating workforce assets to satisfy fair allocation requirements for the given shift requirements as well as workforce asset preferences.

The workforce supply data includes the number of available workforce assets capable of fulfilling or being assigned to a particular needed role during a given time period and/or for a given number of hours. The store demand includes the store shift or time period during which one or more workforce assets are required for a given amount of time (number of hours).

The WF data 204 may indicate that a day shift in a pharmacy requires assignment of four qualified pharmacy workers (trained pharmacists) for an eight-hour time span while a night shift in the same pharmacy may require only two qualified pharmacists for a four-hour time period prior to the pharmacy closing for the evening.

In some examples, the workforce management component 206 collects WF data 204 in a big data platform associated with a plurality of different individual environments. An individual environment may include an area within a physical retail location as well as two or more disparate physical retail locations. Different individual environments within a same physical retail location may include a grocery department selling comestibles within a store and an automotive department selling automotive parts and/or automotive services within the same physical store location. In another example, different individual environments include different physical stores, such as a first retail store located in Dallas, Tex. and another retail store located in Fort Worth, Tex.

The workforce management component 206 in some examples performs data mining on the one or more sources of WF data 204, such as data storage device 202, to obtain the WF data 204 needed to generate one or more allocations. When a given allocation 210 is complete, the workforce management component 206 optionally generates a parity score 222 associated with the allocation 210.

In this example, the workforce management component includes a machine learning component 224 for running a clustering and classification process. The workforce management component 206 identifies the parity score 222 for a given workforce asset during a given time period, a parity score for a given location (store) during a given time period, and/or a parity score for a set of one or more locations (plurality of stores) during a given time period using the allocations data for the corresponding allocations. The parity score 222 provides an indicator of workforce allocation performance, worker satisfaction, and/or fairness/lack of bias in workforce asset assignments.

For example, the workforce management component utilizes all allocations for a given store during a given week to determine a weekly parity score for the store. In another example, the workforce management component utilizes all allocations for a given worker during a month to determine a monthly parity score for the workforce asset. In still another example, the workforce management component 206 utilizes all allocations of workforce assets by one or more stores during a year to generate a yearly parity score for the one or more stores.

The workforce management component 206 utilizes UR-IDs associated with one or more workforce assets to make assignments to each shift and/or allocation. The UR-IDs may be generated by the workforce management component 206 or by a remote computing device, such as server 214. In this example, the UR-IDs 212 for one or more workforce assets are generated and/or stored by a remote server 214. The workforce management component 206 retrieves the UR-IDs 212 via a network or other wired/wireless communications network.

The generated allocations and/or parity scores are presented to one or more users via the UI presentation layer 216 and/or stored in the data storage device 202. The workforce management component 206 outputs the generated allocation 210 to a UI presentation layer 216. The UI presentation layer 216 may include an output device 218. An output device 218 may include a speaker for audio output, a display screen for visual output, a haptic output device for tactile output, an augmented reality device, a virtual reality output device, a projector generating a projected image, or any other type of output device.

The output device 218 in some examples may include a user interface, such as, but not limited to, the user interface component 110 in FIG. 1. A user interface may include a graphical user interface (GUI), a menu-driven interface, a command-line interface, as well as any other type of user interface.

The output allocations and/or parity scores presented to one or more users via the UI presentation layer 216 and/or stored in data storage device 202 may be utilized to identify stores having low parity scores over time and/or alter allocations to improve the parity score.

The workforce management component 206 in some examples performs a feedback loop in which parity scores for a given workforce asset, a given location, or a set of locations are evaluated for anomalies. An anomaly indicates a sub-optimal workforce asset allocation or otherwise indicates an issue/problem with one or more workforce allocations. The parity scores are utilized to generate new allocations and/or modify existing allocations to optimize the parity score(s). This enables a feedback loop to identify anomalies and eliminate the anomalies via updates to generated allocations.

In other examples, parity scores for multiple stores are analyzed by the workforce management component to identify problem areas for improvement, generate insights regarding areas capable of improvement with regard to workforce allocations, and/or create sister-store pairs. A sister-store pair is an assignment of a store with a low parity score with a store having a high parity score. The sister-pair stores share best practices to assist with optimizing parity scores of one or more stores. For example, stores with one or more low parity scores may be partnered with stores having high parity scores to improve the parity score of stores over time.

In other examples, the UI presentation layer 216 is utilized by a user to initiate generation of a parity score and/or an allocation for a selected store or other environment. The UI presentation layer 216 may be utilized to output the parity score, the allocation, a future predicted allocation for a new store, predicted number of workers for a new store, etc.

In still other examples, the parity score 222 is a real-time parity score generated dynamically as an allocation is being created. The parity score 222 for a given allocation is output as the given allocation is being generated by the user, such that a user can modify the allocation to adjust or obtain a better parity score in real-time rather than waiting until after the allocation has been finalized or implemented.

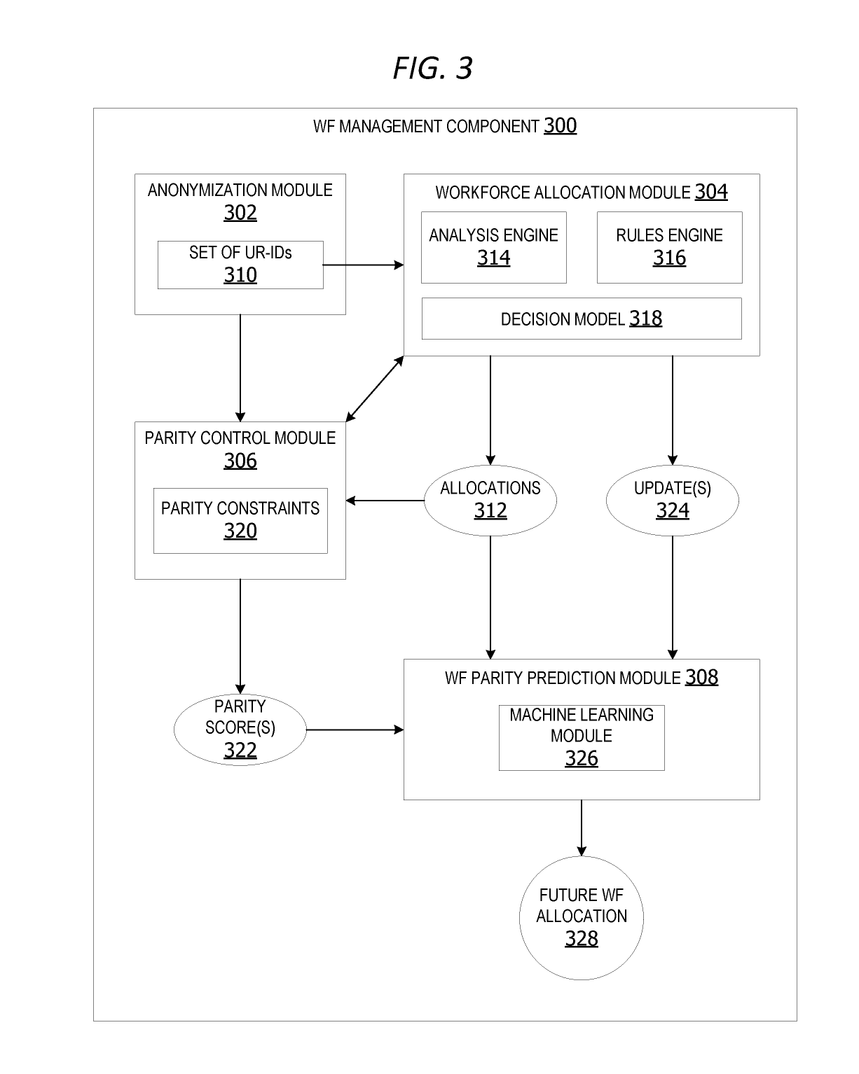

FIG. 3 is an exemplary block diagram illustrating a workforce management component. A workforce management component 300 in some examples includes an anonymization module 302, workforce allocation module 304, parity control module 306, and/or a workforce parity prediction module 308.

The anonymization module 302 generates a set of one or more UR-IDs 310 for each asset. Each workforce asset is assigned to a unique, randomized identifier for each workforce allocation. The anonymization module 302 generates the UR-IDs and updates UR-IDs for each allocation such that a worker is assigned a different UR-ID by the anonymization module for each new allocation. Thus, a single asset may be assigned multiple different UR-IDs where multiple different allocations are generated. Each UR-ID for a given asset corresponds to a specific allocation.

The workforce allocation module 304 utilizes workforce data to generate one or more workforce allocations 312. The allocation (s) include shift plans assigning workforce assets to one or more job duties during a given work shift. A given allocation includes a UR-ID for each worker assigned to each job; scheduled hours to be worked; wages; time parameters; and/or store identifier.

In some examples, the workforce allocation module 304 includes an analysis engine 314, a rules engine 316, and/or a decision model 318 for generating the allocations.

The analysis engine 314 analyzes workforce data, allocations data, and other information associated with the workforce supply and demand corresponding to at least one location or other individual environment, such as a store, distribution center, warehouse, or other environment having one or more workers and duties assigned to those workers. The allocations data includes previous workforce asset allocations used in the past (historical data), current allocations used at other locations, as well as allocations utilized at the current location. In this example, the allocations data is data associated with the current location or locations similar to the current location. For example, if the current location is a store, allocation data from similar stores in similar markets may be utilized by the workforce allocation module 304.

The analysis engine 314 in some examples includes a Reg-ARIMA model. The Reg-ARIMA model calculates the hours needed for staffing, number of workers needed during those hours, etc. The analysis engine 314 determines the actual number of workers needed for each shift.

In other examples, the analysis engine 314 includes an A PRIORI model. The A PRIORI model performs data mining, finding patterns in data, cleaning/filtering data, and normalizing/standardizing data for initial modeling. The A PRIORI model analyzes workforce data to determine how one or more stores operate, identify needs of one or more stores, staff personnel based on type of store, etc.

In some examples, the analysis engine 314 ensures workers of approximately equal standing with regard to status and shifts worked are analyzed on the same basis. For example, full-time employees should not be compared to part-time employees with regard to amount of pay received or number of hours worked. The shifts include, for example, but without limitation, night shift, day shift, weekend shift, weekday shift, and/or holiday shift.

Different shifts may be associated with different hourly pay. For example, and without limitation, a regular shift may include 10,500 available hours for assignment to workers at a rate of $9.00 an hour. The night shift may include only 3,500 hours at a higher rate of $11.00 per hour. Holiday hours may include 2,000 hours available for assignment to workers at a rate of $13.00 per hour. The weekend shift may include 5,500 hours at a rate of $11.00 per hour. At these rates, the holiday hours may be most preferred by workers due to the scarcity of available hours and the higher pay. Likewise, the night shift and weekend shift may be considered high value shifts due to the relative scarcity of available hours and higher pay associated with those work shifts. Therefore, the analysis engine 314 may analyze the worker's role, full-time versus part-time status, and shift preferences, during generation of new allocations. For high demand shifts, each worker is assigned a fair share of the high value shift assignments

The rules engine 316 is a rules-based engine for identifying and analyzing rules, laws, regulations, government compliance requirements, labeling laws, signage requirements, and other constraints influencing workforce asset assignments. For example, a rule may limit a number of overtime hours worked by a particular worker. Another rule may limit a total number of hours permitted to be worked by workers under the age of eighteen years old. Still other constraints may limit certain work assignments to workers having certain credentials, licenses, training, or other expertise. In one example, workers may be required to have training, licensing, or other credentials qualifying them to work in the automotive department prior to being assigned to work in the automotive department. A worker lacking these credentials may be disqualified from work assignments in the automotive department.

The decision model 318 is a machine learning component for anticipating future work assignment requirements, determining an optimal number of workforce assets required during a particular shift, and identifying days and/or times when more workforce assets will be required. For example, the decision model 318 may determine that more workers are needed on Friday afternoons than on Thursday afternoons based on sales trends, historical data, and parity scores.

The parity score indicates workforce demand where the parity score reflects understaffing and/or overstaffing. For example, a low parity score may be due to understaffing during the afternoon shift. The parity score in this example indicates that more workers are needed for the shift.

In another example, the decision modeling may utilize contextual data, behavior models, and pattern analysis to determine staffing requirements for workforce asset allocations. The decision modeling receives the context data from data stores, data service providers, and/or manual user input. Context data includes context information, such as current weather, future weather predictions, current events, news, local events, sports events, holidays, local celebrations, local customs/traditions, and other contextual information.

For example, the decision modeling may determine that more workers are required in a sporting goods department prior to weekends in which the weather forecast predicts pleasant weather for camping than on weekends when cold or rainy weather is predicted based on historical weather patterns, shopping trends, items sold, and current weather.

In yet another example, the decision modeling may increase workforce asset allocations in snack food areas of a foods/grocery department prior to a televised sporting event where analysis of contextual and historical data indicates an increase in snack food sales prior to televised sporting events.

The parity control module 306 receives the set of UR-IDs 310 and the generated allocations 312. The parity control module 306 utilizes parity constraints 320 to generate one or more parity score(s) 322. Each parity score indicates a degree of optimization of a given allocation of a plurality of workers associated with an individual workforce environment or a plurality of individual workforce environments over a given time period.

In some examples, a parity score is calculated as the total number of hours for a given workforce asset during a given pay period divided by the total paid hours for the pay period. The parity score in other examples may be expressed using the following equation:

$$Parity Score = \frac{{Σ}_{i = 1}^{n} ( Paid Hours within Range )}{{Σ}_{i = 1}^{n} ( All Paid Hours )}$$

where the range for full time associates per pay period equals sixty-four to eighty hours (64 to 80 hrs.) and the range for part time workers per pay period equal fifty-six to eighty hours (56 to 80 hrs.).

The workforce parity prediction module 308 includes a machine learning module 326 for analyzing allocations 312, update(s) 324, and parity score(s) 322 to generate a future workforce allocation 328. The future workforce allocation 328 may include a future workforce allocation for an existing individual workforce environment. For example, the future workforce allocation 328 includes a workforce allocation for a future time, such as a future, upcoming year for a currently existing store. The future workforce allocation 328 may also be generated based on context-specific data, such as regional customs, local events, location of store, type of store, local weather, etc.

In other examples, the future workforce allocation 328 is a context-specific prediction of workforce asset requirements across one or more new individual workforce environments, such as a new department, in an existing store. The future workforce allocation 328 may also include a predicted, future workforce allocation for one or more individual workforce environments in a store that does not yet exist, such as a planned new store. In these examples, the workforce management system may determine the number of workforce assets that will be needed at the future store, the square footage of the new store, and the number of hours that will be available for assignment to workforce assets at the new store.

In other examples, the parity control module 306 provides parity score(s) 322 to the workforce allocation module 304. The workforce allocation module 304 utilizes the parity score(s) 322 to generate update(s) 324 to existing allocations, as well as generating new allocations. In some examples, the workforce allocation module 304 obtains one or more different environment parity scores for one or more individual environments. Each individual environment is an area or region associated with one or more staffing positions. One individual environment may include two or more other sub-divided/nested individual environments. For example, a store may be a parent individual environment which includes two or more sub-divided (nested/child) individual environments.

For example, an individual environment may include a nested bakery section individual environment and a nested dairy section individual environment. In yet another example, one individual environment may include a hardware/tools section individual environment, a garden center nested individual environment, and/or an automotive section individual environment within the store individual environment. The store in which the automotive section, garden center, and hardware/tools sections are located is itself an individual environment having its own workforce assets and parity score(s) associated with those workforce assets. Each of the nested individual environments within the store also has its own workforce assets and parity score(s) associated with the workforce assets and/or each nested individual environment.

The workforce allocation module 304 in some examples aggregates the obtained other environment parity scores for one or more nested individual environments to generate a combined parity score for an entity corresponding to the nested individual environments, such as the store, distribution center, or other parent individual environment.

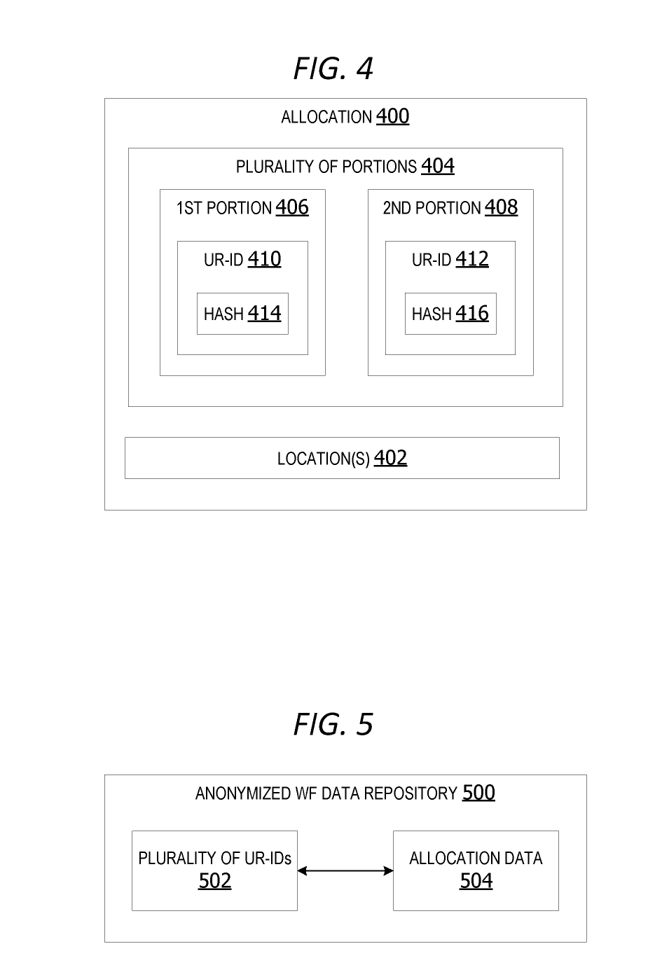

FIG. 4 is an exemplary block diagram illustrating a workforce allocation. The allocation 400 is an assignment of workforce assets to one or more staffing positions for a given time period, such as a work shift at one or more location(s) 402. The one or more locations 402 includes one or more individual environments. An individual environment is an area, region, or other portion of a location in which one or more workforce assets are assigned to work.

The allocation 400 consists of one or more portions. Each portion of the allocations includes one or more staffing positions to be filled by one or more workforce assets. A staffing position is a job title, task, and/or job duty to be performed by a given workforce asset for a given period of time.

In this non-limiting example, a first portion 406 of the allocation 400 is assigned to a workforce asset associated with UR-ID 410. A second portion 408 of the allocation 400 is assigned to a workforce asset associated with UR-ID 412. The UR-ID for each workforce asset is unique and randomized. The UR-ID 410 is different than the UR-ID 412.

In some examples, the UR-ID is a hash value. The hash value is a randomly generated hash value. In this non-limiting example, the UR-ID 410 is a hash 414 value that is different than the hash 416 value of the UR-ID 412.

FIG. 5 is an exemplary block diagram illustrating an anonymized workforce data repository. The anonymized workforce data repository 500 includes a plurality of UR-IDs 502 and allocation data 504. The allocation data 504 includes information describing staffing positions to be filled by workforce assets during certain time periods. Each UR-ID in the plurality of UR-IDs is a UR-ID assigned to a given staffing position for a given allocation.

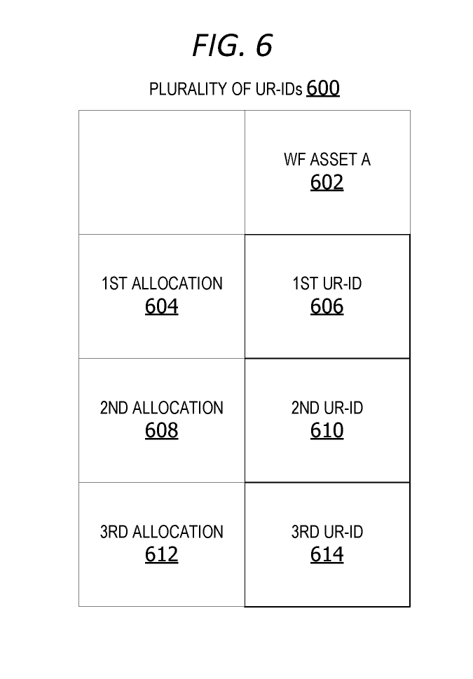

FIG. 6 is an exemplary block diagram illustrating a plurality of unique randomized identifiers generated by an anonymization module. The plurality of UR-IDs 600 includes one or more UR-IDs associated with one or more workforce assets assigned to one or more staffing positions associated with one or more workforce allocations.

A different UR-ID is generated for each allocation for a given workforce asset. In other words, each time the same workforce asset is assigned to a staffing position in a different allocation, a different UR-ID for the same workforce asset is utilized. In this example, a workforce asset “A” 602 assigned to a staffing position by a first allocation 604 is identified in the first allocation 604 by a first UR-ID 606. The same workforce asset “A” 602 assigned to a staffing position in a different, second allocation 608 is identified by a second, different UR-ID 610. Then a third allocation 612 is generated which identifies the workforce asset “A” 602 by a different, third UR-ID 614.

In one non-limiting example, a set of workforce assets include a John Doe, Mary Smith, James Green, and Andy Sanchez. During the first allocation 604, John Doe is assigned to a UR-ID “RXD466”; Mary Smith is given the UR-ID “JN588Z”; James Green is given the UR-ID “M679AN”; and Andy Sanchez is assigned the UR-ID “QZ148Y.” In this non-limiting example, at the second allocation 608, a new and different set of UR-IDs is created for the set of workforce assets. For the second allocation 608, John Doe is assigned to a UR-ID “SEW328”; Mary Smith is given the UR-ID “KR36Z”; James Green is given the UR-ID “Y72HG3”; and Andy Sanchez is assigned the UR-ID “JH261L.” The UR-IDs used in the first allocation are completely different and unrelated to the UR-IDs used for the same workforce assets in the second allocation. If a third allocation is made, the UR-IDs for these four workforce assets are changed again.

The unique, random identifiers generated and utilized during the workforce allocations enable the names and identities of workers to remain anonymous. When a human manager makes a workforce asset allocation, reviews a workforce allocation, or updates/modifies a workforce allocation, the manager does not see any names, addresses, birthdates, worker identifiers, or other personally identifying information for the workforce assets. The manager only sees the work assignments and the UR-IDs. The UR-IDs are random, preventing the manager from determining which UR-ID belongs to which worker. Moreover, the UR-ID for a given worker is changed with every allocation. This prevents a human user from comparing UR-IDs in different allocations to determine which UR-ID belongs to which worker. In this manner, if a human user discovers which worker corresponds to a particular UR-ID used during one allocation, this knowledge will be useless during the next allocation because all the UR-IDs are changed to maintain the anonymity of the allocations. In this manner, the anonymized UR-IDs prevent intentional or unintentional biased workforce allocations and improve security of worker personal information and work schedule information.

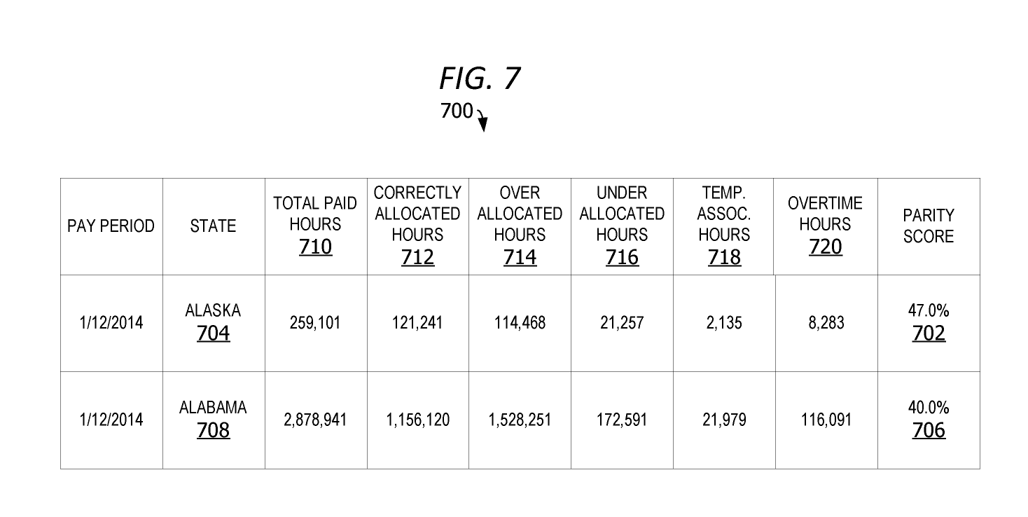

FIG. 7 is an exemplary block diagram illustrating a plurality of parity scores output via a user interface. The UI display 700 outputs a plurality of parity scores for a plurality of individual environments. In this example, each individual environment is a state, such as Florida. The parity scores 702 and 706 are combined parity scores for two or more individual locations associated with one environment, where the environment is a state or other region. In some examples, a combined parity score may include a score for two or more departments/areas within a store, two or more different stores in a given city, stores in one or more counties, states, stores in one or more nations, one or more stores on one or more islands, stores in one or more regions, or any other geographic locations.

In one non-limiting example, the exemplary parity score 702 for a plurality of stores in the state of Alaska 704 is forty-seven percent (47%) while the exemplary parity score 706 for a plurality of stores in Alabama is forty percent (40%).

The parity score is generated using allocation data, such as, but not limited to, total paid hours 710, correctly allocated hours 712, over allocated hours 714, under allocated hours 716, temporary associate hours 718, and/or overtime hours 720. The parity score reflects the “fairness” of the allocated hours. A large number of over allocated hours, under allocated hours, or overtime hours results in a poorer or less desirable parity score. A greater number of correctly allocated hours results in a better or more favorable parity score. The score reflects the efficiency, accuracy, and fairness of the allocations of work hours. The parity score may be generated using models, threshold values, and/or allocation goals.

FIG. 8 is an exemplary flow chart illustrating operation of the computing device to generate an anonymized workforce allocation. The process shown in FIG. 8 may be performed by a workforce management component, executing on a computing device, such as the computing device 102 or 104 in FIG. 1 and/or the computing device 220 or the server 214 in FIG. 2. In some non-limiting examples, the process is performed by a workforce allocation module, such as workforce allocation module 304 in FIG. 3.

The process begins by determining if a new allocation is to be generated at operation 802. An allocation is a shift plan assigning one or more workforce assets to one or more staffing positions. If no, the process moves to operation 814 below. If yes, workforce data for one or more workforce assets is obtained at operation 804. The workforce data is anonymized data including UR-IDs and/or allocation data. Allocation data includes data describing workforce supply (available workers to be assigned) and workforce demand (staffing positions to be assigned), such as, workforce data 118 in FIG. 1 and/or the WF data 204 in FIG. 2. The workforce data is retrieved from a data source or data store, such as, without limitation, the data storage device 126 or 128 in FIG. 1 or the data storage device 202 in FIG. 2.

The UR-IDs are generated for the workforce asset(s) at operation 806. The UR-IDs are generated by an anonymization module of a workforce management component, such as the anonymization module 302 in FIG. 3. In some examples, the anonymization module 302 creates a UR-ID by generating a random hash value. In other examples, the anonymization module 302 selects a cross-reference from a hash pool. The cross-reference is saved in a secured table along with the workforce asset's identifier.

The hash value used for a UR-ID in other examples includes six alphanumeric characters. This enables 36⁶ different combinations for a total of approximately two billion different possible hash values.

The UR-IDs and allocation data for the allocations is stored in an anonymized workforce data repository at operation 808. The anonymized workforce data repository is a repository of workforce data that is anonymized using unique, random identifiers, such as the anonymized workforce data repository 124 in FIG. 1.

An allocation is generated for a set of one or more workforce assets using the anonymized workforce data repository at operation 810. The allocation is generated by a workforce allocation module, such as the workforce allocation module 304 in FIG. 3.

Each UR-ID in the set of UR-IDs is associated with a portion of the generated allocation at operation 812. The UR-IDs are assigned to the allocation portions by the workforce allocation module in some examples. A determination as to whether to update an allocation is made at operation 814. This determination may be made based on parity scores. If a parity score for a given allocation or a given location is below a threshold range of acceptable parity scores, the workforce management component updates the allocation to improve the parity score and/or address any anomalies or sub-optimal workforce assignments in the allocation indicated by the low parity score.

If an allocation is to be updated at operation 814, the process returns to operation 804 to retrieve updated workforce data for the workforce assets. The process iteratively executes operations 804 through 814 in a feedback loop to generate and update workforce allocations to improve parity scores for a given workforce asset, a given location, or a plurality of locations. An update may include an allocation update, such as, but not limited to, update(s) 324 in FIG. 3. In other words, parity scores may be optimized for a given worker, a single store, or a plurality of stores.

When an allocation is not updated at operation 814, the process terminates thereafter. A determination may be made to cease updating a given allocation if the parity score corresponding to the allocation is within an acceptable parity score range or the parity score exceeds the acceptable threshold parity score range.

Thus, in some examples, an anonymized repository is built. When a new allocation is generated, the data in the anonymized repository is utilized to fill the allocation.

While the operations illustrated in FIG. 8 are performed by a computing device, aspects of the disclosure contemplate performance of the operations by other entities. For example, a cloud service may perform one or more of the operations.

FIG. 9 is an exemplary flow chart illustrating operation of the computing device to generate a parity score associated with a workforce allocation. The process shown in FIG. 9 may be performed by a workforce management component executing on a computing device, such as the computing device 102 or 104 in FIG. 1 and/or the computing device 220 or the server 214 in FIG. 2. In some non-limiting examples, the process is performed by a parity control module, such as parity control module 306 in FIG. 3.

The process begins by determining whether new allocation input is received at operation 902. If no, the process proceeds to operation 914 below. If yes, the new allocation input is analyzed at operation 904. The new allocation input is analyzed by an analysis engine, such as analysis engine 314 associated with the workforce allocation module 304 in FIG. 3.

A parity score is generated based on the allocation input data at operation 906. The parity score may be generated by a parity control component, such as the parity control module 306 in FIG. 3. The parity score is stored in a data storage at operation 908. The data storage may include any type of data store, such as, but not limited to, the data storage device 126 or 128 in FIG. 1 and the data storage device 202 in FIG. 2.

The generated parity score is output at operation 912. The parity score may be output to a data storage, a user interface, and/or an output device. In some examples, the parity score is output via a user interface component, such as the user interface component 110 in FIG. 1 or an output device 218 in FIG. 2.

If updated input is received at operation 914, the process returns to operation 904 to analyze the new allocation input. An updated or new parity score is generated using the new allocation input data at operation 906. The process iteratively executes operations 904 through 914 to iteratively generate parity scores until updated input is no longer received at operation 914. The process terminates thereafter.

While the operations illustrated in FIG. 9 are performed by a computing device, aspects of the disclosure contemplate performance of the operations by other entities. For example, a cloud service may perform one or more of the operations.

FIG. 10 is an exemplary flow chart illustrating operation of the computing device to generate a predicted future workforce allocation. The process shown in FIG. 10 may be performed by a workforce management component executing on a computing device, such as the computing device 102 or 104 in FIG. 1 and/or the computing device 220 or the server 214 in FIG. 2. In some non-limiting examples, the process is performed by a workforce parity prediction module, such as the workforce parity prediction module 308 in FIG. 3.

The process begins by obtaining allocations and associated parity scores at operation 1002. The allocations are allocations generated by the workforce management, such as WF management component 116. Context-specific data is extracted at operation 1004. The context-specific data may be extracted from a plurality of sources, including data storage and data service providers. The context-specific data may include data such as weather forecasts, regional customs, local events, location of store, type of store, season, day of the week, local weather, etc. The context-specific data indicates factors which may influence or alter the number of workers needed in a particular store department, the number of hours certain employees will be required, etc.

The context-specific data, obtained allocations and associated parity scores are analyzed at operation 1006. In some examples, a decision model 318 and/or a machine learning module 326, as shown in FIG. 3, analyzes the context-specific data, obtained allocations and associated parity scores.

A predicted future workforce allocation for one or more location(s) is generated based on the results of the analysis at operation 1008. The predicted future workforce allocation is generated in some examples by a workforce parity prediction module, such as the workforce parity prediction module 308 in FIG. 3. The future workforce allocation may include a future workforce allocation for an existing store or for a planned store that does not yet exist.

The predicted future workforce allocation for the location(s) is output at operation 1010. The future workforce allocation may be output via an output device or a user interface. In other examples, the future workforce allocation is stored in a data storage.

A data storage may include, without limitation, the data storage device 126 or 128 in FIG. 1, the data storage device 202 in FIG. 2, or any other data store. A data service provider may include a provider of weather data, news data, local events, or other contextual information available via a server, a cloud service, or any other service provider. Context-specific data may also be provided by manual input via a user interface, such as user interface component 110 in FIG. 1.

While the operations illustrated in FIG. 10 are performed by a computing device, aspects of the disclosure contemplate performance of the operations by other entities. For example, a cloud service may perform one or more of the operations.

FIG. 11 is an exemplary flow chart illustrating operation of the computing device to analyze a plurality of parity scores. The process shown in FIG. 11 may be performed by a workforce management component executing on a computing device, such as the computing device 102 or 104 in FIG. 1 and/or the computing device 220 or the server 214 in FIG. 2. In some non-limiting examples, the process is performed by a parity control module, such as the parity control module 306 in FIG. 3.

The process begins by obtaining a plurality of parity scores at operation 1102. The plurality of parity scores includes two or more parity scores, such as parity score(s) 322 in FIG. 3 and/or parity scores 702 or 706 in FIG. 7. A determination is made as to whether the parity scores are for a single location at operation 1104. If no, the parity scores are aggregated at operation 1106. The aggregation is performed by a parity control, such as parity control module 306 in FIG. 3. A combined parity score is generated for the locations at operation 1108. The combined parity score is output at operation 1110. The process terminates thereafter.

Returning to operation 1104, if the parity scores are for a single location, the scores are analyzed at operation 1112. In some examples, the parity scores are analyzed by an analysis engine, such as, but not limited to, analysis engine 314 in FIG. 3. The scores may be analyzes using one or more rules, threshold scores, decision modeling, parity constraints, machine learning, historical patterns/trends, and/or any other available workforce data.

A combined, environment parity score for the location is generated based on the analysis results at operation 1114. The environment parity score, in some examples, is a score for two or more workforce assets associated with at least one location, such as one or more of the parity score(s) 322 in FIG. 3. The process terminates thereafter.

While the operations illustrated in FIG. 11 are performed by a computing device, aspects of the disclosure contemplate performance of the operations by other entities. For example, a cloud service may perform one or more of the operations.

### ADDITIONAL EXAMPLES

In some examples, an unbiased workforce allocation system is provided for workforce distribution and management in one or more stores, distribution center, warehouse, or other work location. The unbiased workforce allocation system identifies anomalies in paid hours of personnel based on one or more parity scores for personnel. The unbiased workforce allocation system forecasts future workforce requirements based on historical data and/or machine learning predictions. The unbiased workforce allocation system generates a feedback to optimize parity scores of the personnel.

In other examples, the workforce management system provides diversified workforce distribution and forecasting in stores to prevent over-staffing and under-staffing at existing store locations, as well as anticipating staffing requirements at future store locations.

In one example, a system for workforce distribution and management in a store is provided. The system identifies anomalies in paid hours of associates based on the workers' parity scores. The system assigns a uniform and unbiased work hour allocation plan to ensure uniformity in the amount paid to workers at a given store. In some examples, the system utilizes an iterative algorithm based on the parity scores to generate allocation plans having less than a ten percent (10%) standard deviation in the paid amount.

If all full-time cashiers at a given store location receive approximately the same total pay, the parity score for the given store will be high or within an acceptable threshold range. If some part-time cashiers receive higher total pay (work more hours/assigned to high value shifts) than other part-time cashiers, this inequity lowers the parity score. The lower parity score is feedback to enable the allocations to be adjusted to improve the equity of assignments and/or pay received by the part-time workers.

The utilization of UR-IDs and parity scores for allocation also prevents disparity between overtime attained by some workers while other workers have not yet achieved their regular work hours. This also prevents disparity between day shift and night shift workers where there are insufficient staffing positions available during a particular shift to accommodate all the workers that want to work during that particular shift.

In other examples, the system forecasts future workforce requirements based on predictions, context-specific data, and historical data. The system generates feedback to optimize the parity score for a store, location, or set of stores/locations.

A system for workforce management is provided in other examples that include discovering anomalies in paid hours of workers. The system analyzes workforce asset allocations to generate a parity score indicating anomalies and potential anomalies. The system generates a suggested workforce allocation plan to mitigate or eliminate the anomalies. The system alternatively generates forecasted future workforce requirements for existing retail store locations, as well as future, planned stores.

In yet another example, the UR-IDs are anonymized to prevent human users from guessing or determining the identities of workforce assets. When a user receives a suggested workforce asset allocation, the manager only sees randomized and anonymized data. The manager utilizes the UR-IDs to make work assignments. The manager assigns a UR-ID of a workforce asset to a given staffing position without knowing the actual identity of the workforce asset.

In still other examples, changes and overrides to existing or future allocations are permitted. A worker can trade one shift for another, roughly equivalent shift having the same value. A manager can modify a shift plan allocation if it does not create an imbalance between paid hours.

Alternatively, or in addition to the other examples described herein, examples include any combination of the following:
associating a unique hash value with the individual workforce asset on the per allocation basis, by the anonymization module, such that a first unique hash value for the individual workforce asset for the first allocation is different from a second unique hash value for the individual workforce asset for the second allocation;
receiving allocation inputs via the interface;
assigning the one or more workforce assets to the one or more portions of the new allocation, by the workforce allocation module;
wherein the parity control module outputs the parity score to the interface;
wherein the workforce allocation module adjusts assignments of the one or more workforce assets to the one or more portions of the new allocation to generate an updated new allocation in response to the output parity score;
wherein the parity score corresponding to the generated new allocation is associated with a location;
wherein a plurality of parity scores for a plurality of associated locations is aggregated to generate a combined parity score for the plurality of associated locations;
a workforce parity prediction module that obtains a plurality of generated allocations and associated parity scores corresponding to a plurality of locations, extracts context-specific data associated with individual locations of the plurality of locations, and uses the extracted context-specific data and obtained allocations and parity scores to predict a future workforce allocation for a current location that satisfies parity constraints;
wherein the workforce parity prediction module uses the extracted context-specific data and obtained allocations and parity scores to predict a workforce allocation for a future location that satisfies parity constraints;
wherein the new allocation includes a plurality of portions, and wherein one or more workforce assets from the plurality of workforce assets associated with the individual environment are assigned to one or more portions of the plurality of portions;
analyzing the generated new allocation, including the one or more workforce assets assigned to the one or more portions, to generate a parity score for the generated new allocation;
receiving allocation inputs via the communication network to assign the one or more workforce assets to the one or more portions of the plurality of portions;
analyzing the assigned one or more workforce assets as the allocation inputs are received to generate a dynamic parity score, such that the dynamic parity score changes as an individual allocation input is processed to reflect an impact of the individual allocation input on the dynamic parity score;
generating a unique hash value representing the individual workforce asset and a corresponding individual allocation;
analyzing the first allocation and the second allocation associated with the individual environment, including one or more workforce assets assigned to one or more portions of the first allocation and the second allocation;
generating a first parity score for the first allocation and a second parity score for the second allocation;
computing an environment parity score for the individual environment using the first parity score and the second parity score;
obtaining other environment parity scores for one or more other individual environments associated with the individual environment;
aggregating the obtained other environment parity scores with the computed environment parity score to generate a combined parity score for an entity corresponding to the individual environments;
obtaining a plurality of generated allocations and associated parity scores corresponding to a plurality of individual environments;
extracting context-specific data associated with one or more individual environments of the plurality of individual environments;
generating a predicted workforce allocation that satisfies parity constraints for the individual environment using the extracted context-specific data and obtained allocations and parity scores;
obtaining a plurality of generated allocations and associated parity scores corresponding to a plurality of individual environments;
extracting context-specific data associated with one or more individual environments of the plurality of individual environments;
generating a predicted workforce allocation that satisfies parity constraints for a predicted individual environment using the extracted context-specific data and obtained allocations and parity scores;
associating a unique hash value with the individual workforce asset on the per allocation basis, such that a first unique hash value for the individual workforce asset for the first allocation is different from a second unique hash value for the individual workforce asset for the second allocation;
outputting the parity score to the workforce allocation module, and wherein responsive to the output parity score the workforce allocation module adjusts assignments of the one or more workforce assets to the one or more portions of the new allocation to generate an updated new allocation.

At least a portion of the functionality of the various elements in FIG. 1, FIG. 2, FIG. 3, FIG. 4, FIG. 5, FIG. 6, and FIG. 7 may be performed by other elements in FIG. 1, FIG. 2, FIG. 3, FIG. 4, FIG. 5, FIG. 6, and FIG. 7, or an entity (e.g., processor, web service, server, application program, computing device, etc.) not shown in FIG. 1, FIG. 2, FIG. 3, FIG. 4, FIG. 5, FIG. 6, and FIG. 7.

In some examples, the operations illustrated in FIG. 8, FIG. 9, FIG. 10, and FIG. 11 may be implemented as software instructions encoded on a computer-readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for anonymized workforce allocation. For example, the elements illustrated in FIG. 1, FIG. 2, FIG. 3, FIG. 4, FIG. 5, FIG. 6, and FIG. 7, such as when encoded to perform the operations illustrated in FIG. 8, FIG. 9, FIG. 10, and FIG. 11, constitute exemplary means for obtaining workforce data associated with an individual environment via a communication network coupled to the at least one processor; exemplary means for computing individual unique randomized identifiers for individual workforce assets in the plurality of workforce assets associated with the individual environment on a per allocation basis, such that a first unique randomized identifier is associated with an individual workforce asset for a first allocation and a second unique randomized identifier is associated with the individual workforce asset for the second allocation; exemplary means for storing the generated individual unique randomized identifiers and corresponding allocation data at an anonymized workforce data repository; and exemplary means for generating a new allocation for the individual environment using the anonymized workforce data repository, including computing a new unique randomized identifier for the individual workforce asset and associating the computed new unique randomized identifier with a corresponding portion of the new allocation.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for unbiased workforce allocation, the system comprising:
an interface coupled to a communication network;
at least one processor coupled to the interface via the communication network;
an anonymization module, implemented on the at least one processor, that:
obtains workforce data from a data storage device, including information corresponding to a plurality of workforce assets and a plurality of allocations;
generates individual unique randomized identifiers for individual workforce assets in the plurality of workforce assets on a per allocation basis, such that an individual workforce asset is associated with a first unique randomized identifier for a first allocation and a second unique randomized identifier for a second allocation; and
stores the generated individual unique randomized identifiers and corresponding allocation data at an anonymized workforce data repository;
a workforce allocation module, implemented on the at least one processor, that:
generates a new allocation using the anonymized workforce data repository to assign one or more workforce assets to one or more portions of the generated new allocation; and
a parity control module, implemented on the at least one processor, that:
analyzes the generated new allocation in real-time to generate a parity score corresponding to allocation of the one or more workforce assets relative to the generated new allocation; and
outputs the generated parity score.

2. The system of claim 1, wherein the anonymization module associates a unique hash value with the individual workforce asset on the per allocation basis, such that a first unique hash value for the individual workforce asset for the first allocation is different from a second unique hash value for the individual workforce asset for the second allocation.

3. The system of claim 1, wherein the workforce allocation module receives allocation inputs via the interface and assigns the one or more workforce assets to the one or more portions of the new allocation based on the allocation inputs.

4. The system of claim 1, wherein the parity control module outputs the parity score to the interface, and wherein responsive to the output parity score the workforce allocation module adjusts assignments of the one or more workforce assets to the one or more portions of the new allocation to generate an updated new allocation.

5. The system of claim 1, wherein the parity score corresponding to the generated new allocation is associated with a location.

6. The system of claim 5, wherein a plurality of parity scores for a plurality of associated locations is aggregated to generate a combined parity score for the plurality of associated locations.

7. The system of claim 1, further comprising:
a workforce parity prediction module that obtains a plurality of generated allocations and associated parity scores corresponding to a plurality of locations, extracts context-specific data associated with individual locations of the plurality of locations, and uses the extracted context-specific data and obtained allocations and parity scores to predict a future workforce allocation for a current location that satisfies parity constraints.

8. The system of claim 7, wherein the workforce parity prediction module uses the extracted context-specific data and obtained allocations and parity scores to predict a workforce allocation for a future location that satisfies parity constraints.

9. A method for context-specific unbiased workforce forecasting implemented on at least one processor, comprising:
obtaining workforce data associated with an individual environment via a communication network coupled to the at least one processor, the workforce data including information corresponding to a plurality of workforce assets;
computing individual unique randomized identifiers for individual workforce assets in the plurality of workforce assets associated with the individual environment on a per allocation basis, such that a first unique randomized identifier is associated with an individual workforce asset for a first allocation and a second unique randomized identifier is associated with the individual workforce asset for a second allocation;
storing the individual unique randomized identifiers and corresponding allocation data at an anonymized workforce data repository; and
generating a new allocation for the individual environment using the anonymized workforce data repository, including computing a new unique randomized identifier for the individual workforce asset and associating the computed new unique randomized identifier with a corresponding portion of the new allocation.

10. The method of claim 9, wherein the new allocation includes a plurality of portions, and wherein one or more workforce assets from the plurality of workforce assets associated with the individual environment are assigned to one or more portions of the plurality of portions.

11. The method of claim 10, further comprising:
analyzing the generated new allocation, including the one or more workforce assets assigned to the one or more portions, to generate a parity score for the generated new allocation.

12. The method of claim 10, wherein generating the new allocation further comprises:
receiving allocation inputs via the communication network to assign the one or more workforce assets to the one or more portions of the plurality of portions; and
analyzing the assigned one or more workforce assets as the allocation inputs are received to generate a dynamic parity score, such that the dynamic parity score changes as an individual allocation input is processed to reflect an impact of the individual allocation input on the dynamic parity score.

13. The method of claim 9, wherein computing the individual unique randomized identifiers further comprises:
generating a unique hash value representing the individual workforce asset and a corresponding individual allocation.

14. The method of claim 9, further comprising:
analyzing the first allocation and the second allocation associated with the individual environment, including one or more workforce assets assigned to one or more portions of the first allocation and the second allocation;
generating a first parity score for the first allocation and a second parity score for the second allocation; and
computing an environment parity score for the individual environment using the first parity score and the second parity score.

15. The method of claim 14, further comprising:
obtaining other environment parity scores for one or more other individual environments associated with the individual environment; and
aggregating the obtained other environment parity scores with the computed environment parity score to generate a combined parity score for an entity corresponding to the individual environments.

16. The method of claim 9, further comprising:
obtaining a plurality of generated allocations and associated parity scores corresponding to a plurality of individual environments;
extracting context-specific data associated with one or more individual environments of the plurality of individual environments; and
generating a predicted workforce allocation that satisfies parity constraints for the individual environment using the extracted context-specific data and obtained allocations and parity scores.

17. The method of claim 9, further comprising:
obtaining a plurality of generated allocations and associated parity scores corresponding to a plurality of individual environments;
extracting context-specific data associated with one or more individual environments of the plurality of individual environments; and
generating a predicted workforce allocation that satisfies parity constraints for a predicted individual environment using the extracted context-specific data and obtained allocations and parity scores.

18. One or more computer storage devices having computer-executable instructions stored thereon for context-specific unbiased workface allocation, which, on execution by a computer, cause the computer to perform operations comprising:
an anonymization component that obtains workforce data, including information corresponding to a plurality of workforce assets and a plurality of allocations, generates unique randomized identifiers for the individual workforce assets on a per allocation basis, and stores the generated unique randomized identifiers and corresponding allocation data at an anonymized workforce data repository;
a workforce allocation component that generates a new allocation using the anonymized workforce data repository to assign one or more workforce assets to one or more portions of the generated new allocation; and
a parity control component that analyzes the generated new allocation in real-time to output a parity score corresponding to allocation of the one or more workforce assets relative to the generated new allocation.

19. The one or more computer storage devices of claim 18, wherein the anonymization component further:
associates a unique hash value with the individual workforce asset on the per allocation basis, such that a first unique hash value for the individual workforce asset for a first allocation is different from a second unique hash value for the individual workforce asset for a second allocation.

20. The one or more computer storage devices of claim 19, wherein the parity control component further:
outputs the parity score to a workforce allocation module, and wherein responsive to the output parity score the workforce allocation module adjusts assignments of the one or more workforce assets to the one or more portions of the new allocation to generate an updated new allocation.
